(19) United States
(12) Patent Application Publication
(10) Pub. No.: US 2003/0004443 A1
(43) Pub. Date: Jan. 2, 2003

(54) Adjustable foot acupressure and pain relief platform

(76) Inventor: Kwok Ching Chan, Kowloon (HK)

Correspondence Address: OSTROLENK FABER GERB & SOFFEN, 1180 AVENUE OF THE AMERICAS, NEW YORK, NY, 100368403

(21) Appl. No.: 09/999,543

(22) Filed: Oct. 24, 2001

(30) Foreign Application Priority Data
Jun. 27, 2001 (HK) 01104429.2

(51) Int. Cl. A61H 1/00

(52) U.S. Cl. 601/22

(57) ABSTRACT

A sole massage and pain-relief board that includes a substrate and a plurality of massage grains. A plurality of small orifices are formed within the outlines of the two footprints on the substrate. Each orifice is individually numbered and the orifices are distributed in positions corresponding to the positions of the reflex acupuncture points on the soles of the feet. The lower ends of the massage grains possess short handles to permit the insertion of the massage grains into the small orifices. The massage grains can be disposed on the substrate in positions that correspond to the acupuncture points on the soles of the feet for different types of pain in order to apply pressure to different locations on the soles of the feet of the sufferer, thus providing a targeted pain-relief effect. Better effects can be achieved by employing magnetic type massage grains to provide stimulus.

### BACKGROUND OF THE INVENTION

This invention relates to a pain-relief therapeutic device that stimulates the acupressure points on the soles of the feet according to the theory of meridian (the channel in which energy travels) and foot reflexology.

When people suffer from pain, they usually ingest analgesics from their doctors. Some of them will also seek help from physical therapists to relieve their pain, if it is musculo-skeletal in nature. Furthermore, many people are willing to purchase all sorts of pain-relieving devices that are available on the market as home remedies. The most common devices are products in which pressure is applied to the soles of the feet, such as massage shoes and insoles.

There are two patented products on the market claimed to provide a pain-relieving effect through the application of massage to the sole of the foot. They are “Massage Insole with Massage Grains Distributed According to the Acupuncture Pressure Points of the Sole of the Human Foot” (Chinese Patent Number 94202570) and “Health Insole” (Chinese Patent Number 97239346). Both products have non-adjustable massage grains that are fixed and distributed over the entire insole. As a result, massage is applied to the entire foot instead of a particular area. According to the theory of meridian and foot reflexology, an effect of pain relief from a certain condition can be achieved through stimulating a particular area on the sole of the foot rather than the entire sole. Therefore, the two products mentioned may only give rise to health effects over the entire body but not have any effect on pain relief for a specific condition.

### SUMMARY OF THE INVENTION

The object of the present invention entitled “Adjustable Foot Acupressure and Pain Relief Platform” is to provide novel massage and pain relief through stimulating the acupressure points on the soles of the feet. It is easy to use and it can be employed for self- treatment at home. According to the theory of meridian and foot reflexology, excellent analgesic effect can be achieved by applying pressure to particular acupressure points on the soles of feet. For this “Adjustable Foot Acupressure and Pain Relief Platform,” healing can be provided through positioning the adjustable massage grains on the corresponding area on the platform, and when pressure is applied on them.

The present invention is simple in structure. It is a massage and pain-relief board that comprises a substrate and a set of massage grains. All of these may be made of plastic resin, metal, wood, hard resin, or a mixtures of magnetic material with other materials. The substrate is in the form of left and right footprints with a plurality of small orifices on the surface. These small orifices are distributed to reflect the positions of the acupressure points of the sole of feet accordingly. Each small orifice is individually numbered to facilitate the positioning of the massage grain. The massage grain may be hemispherical or conical in shape, with a short projection on the lower end that can be inserted into the selected orifices corresponding to the area of pain. The other end of the massage grain is projected above the surface of the substrate in order to provide stimulation to the corresponding acupressure points on the soles of the foot.

To use the device, one inserts the adjustable massage grains into selected orifices on the substrate by following the instruction in the booklet that comes with the product. The instruction booklet will state clearly where the user should position the massage grains on the substrate for a certain pain condition. A sensation of “de qi” (i.e. a feeling of soreness, numbness, and aching pain) will be produced when the user treads on the massage-grains-filled substrate and maintains the pressure on them for a specified amount of time, resulting in a therapeutic analgesic effect.

Traditional Chinese Medicine (TCM) recognizes that there are meridians over the entire body in which energy flows. It is believed that acupressure points are areas of higher concentration of energy and most of them are located along the meridians. Moreover, according to foot reflexology, each organ possesses a corresponding reflex region on the sole of the foot. Thus, the flow of energy within the body will be stimulated either through massaging to the reflex region or applying acupuncture/acupressure to the selected points on the sole of the foot to produce a therapeutic effect.

The present invention entitled “Adjustable Foot Acupressure and Pain Relief Platform” is therefore a product of the application of foot reflexology, acupuncture therapy and traditional Chinese medicine. Its relative simple design contributes to a low production cost. It is user friendly and it provides a form of inexpensive, non-invasive acupuncture and massage therapy that can be used for self-treatment by any individuals who suffer from musculo-skeletal pain.

### BRIEF DESCRIPTION OF THE DRAWINGS

FIG. 1 is a plan view of the present invention.

FIG. 2 is a side elevation of a spherically shaped massage grain used with the invention.

FIG. 3 is a side elevation of a spherically shaped massage grain for the invention.

### DESCRIPTION OF PREFERRED EMBODIMENTS

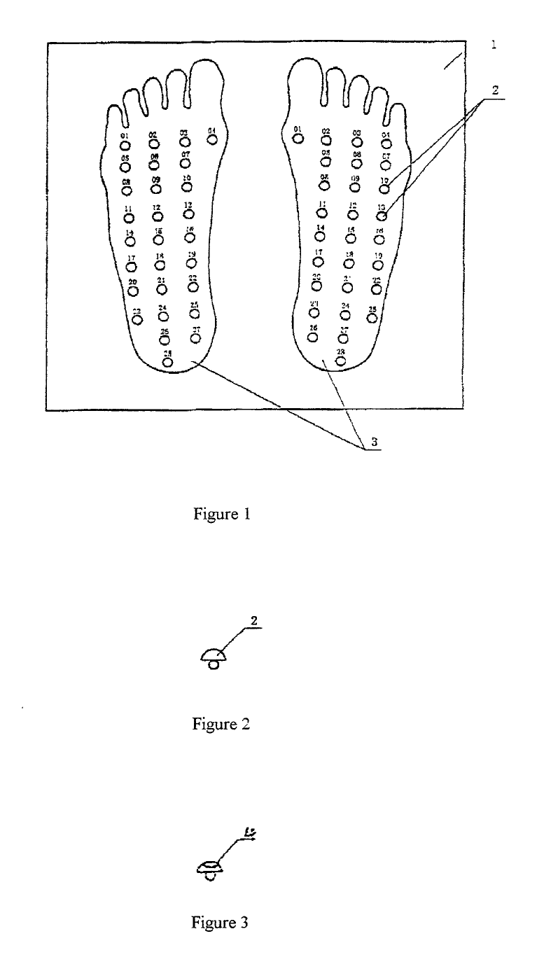

In FIG. 1, the sole massage and pain-relief board of the invention comprises a substrate 1 and movable or removable massage grains 2. The substrate has left and right footprints 3 although a design with one footprint or a fraction of an entire footprint may be provided. Small orifices are formed within the outlines of the footprints at positions that correspond to the reflex acupuncture pressure points on the soles of the feet. Each small orifice is individually numbered and marked on the substrate. There are many of the massage grains 2. The lower end of each massage grain is provided with a short handle or projection by which the massage grain can be conveniently inserted into or removed from a selected orifice in the substrate. The massage grains may be hemispherical in shape, as illustrated in FIG. 2, or may be conical in shape or may have other shapes.

The sole massage and pain-relief board and the individual massage grains may be formed of plastic resin, metal, wood, hard resin or of other materials. The grains may additionally be or may include magnets and these may be mixed with the other materials noted.

When the device is to be employed, the sufferer locates the marked number of the small orifice within the footprint 3 on the substrate 1 that corresponds to a particular acupuncture reflex position on the sole of the left or right foot and then inserts one of the massage grains 2 or 4 into the small orifice. For example, in the case of pain in the waist, the corresponding small orifices are numbers 07 and 12. Thus the user inserts the massage grains 2 or 4 into the small orifices numbers 07 and 12, and then the user stands with both feet upon the massage and pain-relief board, whereupon the massage grains are fixed accurately at reflex positions on the soles of the feet for the waist and they massage the soles of the feet and are able to stop or alleviate pain at the waist.

This type of pain-relief board is simple in structure, simple to manufacture, is convenient to use, and can be employed by the sick for self-treatment within the family of various types of illness.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A massage board for the sole of a foot comprising a substrate for disposition beneath the foot and including a footprint outline thereon;
a plurality of small size orifices formed on the substrate within the footprint and distributed at locations over the footprint to correspond to the positions of the reflex acupuncture points, which points are respectively for different pain systems that can be acted upon through the soles of the feet; each of the orifices having a respective identifier associated with it enabling a user to identify selected orifices;
a plurality of massage grains, each including a short handle which is removably insertable into one of the orifices so that with the massage grain handle positioned in selected ones of the orifices, the massage grains project above the surface of the substrate in the footprint,
whereby a user may select identified locations at selected ones of the orifices for the massage grains, related to a particular selection of acupuncture points.

2. The massage board of claim 1, wherein the massage grains have rounded tops.

3. The massage board of claim 1, wherein the massage grains are comprised of magnets.

4. The massage board of claim 1, wherein the massage grains are formed of a plastic resin.

5. The massage board of claim 1, wherein the massage grains are formed of a mixture of a plastic resin with magnets therein.

6. The massage board of claim 1, wherein the massage grains are formed of wood.

7. The massage board of claim 1, wherein the massage grains are formed of a mixture of wood and magnets.

8. The massage board of claim 1, wherein the massage grains are formed of a hard resin.

9. The massage board of claim 1, wherein the massage grains are formed of a mixture of magnets with hard resin.

10. The massage board of claim 1, further comprising a respective one of the footprints for both the right and the left foot on the substrate, each footprint including respective ones of the orifices and the massage grains having handles receivable in the orifices within the outlines of both of the footprints.
